(19) United States
(12) Patent Application Publication
(10) Pub. No.: US 2008/0095993 A1
(43) Pub. Date: Apr. 24, 2008

(54) Master Substratus and Methods for Mastering

(75) Inventors: Erwin Rinaldo Meinders, Eindhoven (NL); Hinke Sijvert Petronella Bouwmans, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,999

(22) PCT Filed: Dec. 21, 2005
(86) PCT No.: PCT/IB05/54368

§ 371 Date: Jun. 28, 2007

(30) Foreign Application Priority Data
Jan. 6, 2005 (EP) 05100050.3

(51) Int. Cl. G11B 7/26; B32B 17/06

(52) U.S. Cl. 428/210; 216/11; 428/195.1

(57) ABSTRACT

The present invention relates to a master substrate (10) for creating a high-density relief structure, particularly a master substrate (10) for making a stamper for the mass fabrication of optical discs or a master substrate for creating a stamp for micro contact printing, wherein an organic dye layer (12) is provided for creating the high-density relief structure. The present invention further relates to a method for providing a high density relief structure on a master substrate (10) comprising an organic dye layer (12), the method comprising the following steps: applying dye bleaching laser pulses on regions (30) of the master substrate (10) where pits (32) are to be formed; and removing the bleached regions (30) of the organic dye layer (12) by an etching process. The present invention also relates to a method for providing a high density relief structure on a master substrate (10), the method comprising the following steps:—providing a master substrate (10) comprising at least a polycarbonate layer (14) carrying an organic dye layer (12); forming bumps (20) at the dye/polycarbonate interface (16) by applying laser pulses; and removing the remaining dye layer by an etching process.

### FIELD OF THE INVENTION

The present invention relates to a master substrate for creating a high-density relief structure, particularly a master substrate for making a stamper for the mass fabrication of optical discs or a master substrate for creating a stamp for micro contact printing. Furthermore, the present invention relates to a method for providing a high density relief structure on a master substrate and a method for providing a high density relief structure on a master substrate comprising an organic dye layer. The invention also relates to methods for making stampers, optical discs, stamps, and microprints, respectively.

### BACKGROUND OF THE INVENTION

Relief structures that are manufactured on the basis of optical processes can, for example, be used as a stamper for the mass replication of read-only memory (ROM) and pre-grooved write-once (R) and rewriteable (RE) discs. The manufacturing of such a stamper, as used in a replication process, is known as mastering.

In conventional mastering, a thin photosensitive layer, spincoated on a glass substrate, is illuminated with a modulated focused laser beam. The modulation of the laser beam causes that some parts of the master substrate are being exposed by UV light while the intermediate areas in between the pits to be formed remain unexposed. While the disc rotates, and the focused laser beam is gradually pulled to the outer side of the disc, a spiral of alternating illuminated areas remains. In a second step, the exposed areas are being dissolved in a so-called development process to end up with physical holes inside the photo-resist layer. Alkaline liquids such as NaOH and KOH are used to dissolve the exposed areas. The structured surface of the master substrate is subsequently covered with a thin Ni layer. In a galvanic process, this sputter-deposited Ni layer is further grown to a thick manageable Ni substrate comprising the inverse pit structure. This Ni substrate with protruding bumps is separated from the master substrate and is called the stamper.

Phase-transition mastering (PTM) is a relatively new method to make high-density ROM and RE/R stampers for mass-fabrication of optical discs. Phase-transition materials can be transformed from the initial unwritten state to a different state via laser-induced heating. Heating of the recording stack can, for example, cause mixing, melting, amorphization, phase-separation, decomposition, etc. One of the two phases, the initial or the written state, dissolves faster in acids or alkaline development liquids than the other phase does. In this way, a written data pattern can be transformed to a high-density relief structure with protruding bumps or pits. Also in this case the patterned substrate can be used as a stamper for the mass-fabrication of high-density optical discs or as a stamp for micro-contact printing.

In this connection it was already proposed to use fast-growth phase-change materials and recording stacks for phase-transition mastering. The growth-dominated phase-change materials possess a high contrast in dissolution rate of the amorphous and crystalline phase. The amorphous marks, obtained by melt-quenching of the crystalline material, can be dissolved in concentrated conventional alkaline developer liquids, such as KOH and NaOH but also in acids like HCl, HNO₃ and H₂SO₄. Re-crystallization in the tail of the mark can be used to reduce the mark length in a controlled manner. In particular in case of the smallest mark, the I2, the re-crystallization in the tail of the mark can lead to a crescent mark, with a length shorter than the optical spot size. In this way, the tangential data density can be increased.

A challenge of such a material system might be the relatively large number of recording stack layers needed to optimize the thermal and optical behavior of the recording stack. Another difficulty is the ability to make deep pit structures with such a material system.

It is therefore an object of the present invention to provide methods and master substrates of the type mentioned at the beginning that enable mastering on the basis of a relative simple recording stack.

### SUMMARY OF THE INVENTION

This object is solved by the features of the independent claims. Further developments and preferred embodiments of the invention are outlined in the dependent claims.

In accordance with a first aspect of the present invention the above object is solved by a master substrate for creating a high-density relief structure, particularly a master substrate for making a stamper for the mass fabrication of optical discs or a master substrate for creating a stamp for micro contact printing, wherein an organic dye layer is provided for creating the high-density relief structure. This solution is based on the finding that organic dye layers which are presently used, for example, in connection with CD-R and DVD+R applications are also suitable to be used in connection with mastering processes. The thickness of the organic dye layer is, for example, between 20 and 150 nm, and preferably between 60 and 80 nm.

For some embodiments of the master substrate in accordance with the invention the organic dye layer comprises a planar lower surface. A planar lower surface of the organic dye layer enables the formation of a high-density relief structure that is for example independent from any pre-grooved pattern used for tracking in conventional applications.

However, with other embodiments of the master substrate in accordance with the invention it is preferred that the organic dye layer comprises a pre-grooved lower surface. For example, a pre-grooved substrate carrying a pre-grooved organic dye layer can be used to make a high-density relief structure, wherein the pre-groove leads to a so-called super-resolution, because only the narrow grooves are filled with dyes while the adjacent lands are hardly covered with dye.

With preferred embodiments of the master substrate in accordance with the invention the dye of the organic dye layer is selected from the following group: AZO, cyanine, phthalocyanine.

In accordance with a first general embodiment of the present invention the organic dye layer is carried by polycarbonate. Such an unwritten master substrate provides the possibility to form bumps at the dye-polycarbonate interface by applying laser pulses. This is due to the fact that for some types of dyes, for instance phthalocyanine dyes, mixing of dye and polycarbonate occurs at the dye/polycarbonate interface, as it is known as such. In conventional applications these bumps cause a reduction of the optical path length and also contribute to the read-out of a written mark. In contrary thereto, it is one aspect of the present invention to use these bumps for creating high density relief structures by removing the remaining dye layer by an etching process. With this etching process the remaining dye layer is not selectively etched, i.e. both the written and unwritten dye is removed. However, selective etching is present between polycarbonate and dye as well as between the polycarbonate/dye mixture and the remaining dye layer.

Such a processing of the master substrate in accordance with the first general embodiment leads to a master substrate, wherein the master substrate comprises a high-density relief structure formed by bumps created by laser pulses at an interface between an organic dye layer and a polycarbonate layer.

In accordance with a second general embodiment of the master substrate in accordance with the invention the organic dye layer is arranged above a glass substrate. This solution is based on the finding that regions of the organic dye layer which have been bleached by laser pulses may become sensitive for etching processes, particularly alkaline etching liquids, such as KOH and NaOH.

A master substrate in accordance with the second general embodiment of the present invention, that is processed as mentioned above, leads to a master substrate, wherein the master substrate comprises a high-density relief structure formed in the organic dye layer.

For the second general embodiment it is preferred that a metallic reflector layer is arranged between the glass substrate and the dye layer. Such a metallic reflector layer can, for example, be a Ni layer. The thickness of the metallic reflector layer is, for example, between 5 and 100 nm, and preferably between 10 and 40 nm. The metallic reflector layer is provided to enhance the absorption profile in the dye layer. It will also sharpen the absorption profile in the organic dye layer and thus cause a steeper thermally degraded/bleached region.

With all embodiments of the master substrate in accordance with the invention it can be advantageous, if the recording stack further comprises an absorption layer arranged on top of the organic dye layer. The thickness of such an absorption layer is, for example, between 5 and 40 nm, and preferably between 5 and 10 nm. The absorption layer is preferably removed via etching or peeling off. Such an absorption layer also enhances the absorption profile in the organic dye layer.

In accordance with a second aspect of the present invention the above object is solved by a method for providing a high density relief structure on a master substrate comprising an organic dye layer, the method comprising the following steps:

applying dye bleaching laser pulses on regions of the master substrate where pits are to be formed; and

removing the bleached regions of the organic dye layer by an etching process.

This method is preferably applied to the second general embodiment of the master substrate in accordance with the invention. The etching process can be performed by using an alkaline etching liquid or an acid etching liquid. Also in this case, the dye layer may be of the type AZO dye, cyanine or phthalocyanine.

In accordance with a third aspect of the present invention, the above object is solved by a method for providing a high density relief structure on a master substrate, the method comprising the following steps:

providing a master substrate comprising at least a polycarbonate layer carrying an organic dye layer;

forming bumps at the dye/polycarbonate interface by applying laser pulses; and

removing the remaining dye layer by an etching process.

The method in accordance with the third aspect of the present invention is preferably carried out on the basis of a master substrate in accordance with the first general embodiment mentioned above.

In accordance with a fourth aspect of the present invention, there is provided a method for making a stamper for the mass fabrication of optical discs (50), the method comprising the following steps:

providing a master substrate comprising an organic dye layer;

applying dye bleaching laser pulses on regions of the master substrate where pits are to be formed;

removing the bleached regions of the organic dye layer by an etching process; and

making the stamper on the basis of the master substrate.

In accordance with a fifth aspect of the present invention, there is provided a method for making an optical disc, the method comprising the following steps:

providing a master substrate comprising an organic dye layer;

applying dye bleaching laser pulses on regions of the master substrate where pits are to be formed;

removing the bleached regions of the organic dye layer by an etching process;

making a stamper on the basis of the master substrate; and

using the stamper to make the optical disc.

In accordance with a sixth aspect of the present invention, there is provided a method for making a stamp for micro contact printing, the method comprising the following steps:

providing a master substrate comprising an organic dye layer;

applying dye bleaching laser pulses on regions of the master substrate where pits are to be formed;

removing the bleached regions of the organic dye layer by an etching process; and

making the stamp on the basis of the master substrate.

In accordance with a seventh aspect of the present invention, there is provided a method for making a microprint, the method comprising the following steps:

providing a master substrate comprising an organic dye layer;

applying dye bleaching laser pulses on regions of the master substrate where pits are to be formed;

removing the bleached regions of the organic dye layer by an etching process;

making a stamp on the basis of the master substrate; and

using the stamp to make the microprint.

In accordance with a eighth aspect of the present invention, there is provided a method for making a stamper for the mass fabrication of optical discs, the method comprising the following steps:

providing a master substrate comprising at least a polycarbonate layer carrying an organic dye layer;

forming bumps at the dye/polycarbonate interface by applying laser pulses;

removing the remaining dye layer by an etching process; and

making the stamper on the basis of the master substrate.

In accordance with a ninth aspect of the present invention, there is provided a method for making an optical disc, the method comprising the following steps:

providing a master substrate comprising at least a polycarbonate layer carrying an organic dye layer;

forming bumps at the dye/polycarbonate interface by applying laser pulses;

removing the remaining dye layer by an etching process;

making a stamper on the basis of the master substrate; and

using the stamper to make the optical disc.

In accordance with a tenth aspect of the present invention, there is provided a method for making a stamp for micro contact printing, the method comprising the following steps:

providing a master substrate comprising at least a polycarbonate layer carrying an organic dye layer;

forming bumps at the dye/polycarbonate interface by applying laser pulses;

removing the remaining dye layer by an etching process; and

making the stamp on the basis of the master substrate.

In accordance with a eleventh aspect of the present invention, there is provided a method for making a microprint, the method comprising the following steps:

providing a master substrate comprising at least a polycarbonate layer carrying an organic dye layer;

forming bumps at the dye/polycarbonate interface by applying laser pulses;

removing the remaining dye layer by an etching process;

making a stamp on the basis of the master substrate; and

using the stamp to make the microprint.

These and other aspects of the invention will be apparent from and elucidated with reference to the embodiments described hereinafter.

Furthermore, it is clear that the solutions in accordance with the fourth to eleventh aspects of the invention may be further developed corresponding to the embodiments and details disclosed in connection with the first to third aspects of the invention, and all combinations of the respective features shall be deemed to be disclosed hereby, even if presently not explicitly claimed with the appending claims.

### BRIEF DESCRIPTION OF THE DRAWINGS

FIGS. 1a to 1c schematically show a first example of the first general embodiment of the master substrate in accordance with the present invention during processing by a method in accordance with the invention;

FIG. 1d schematically shows the making of a stamper and stamp, respectively;

FIG. 1e schematically shows the making of an optical disc;

FIG. 1f schematically shows the making of a microprint;

FIGS. 2a to 2c schematically show a second example of the first general embodiment of the master substrate in accordance with the present invention during processing by a method in accordance with the invention;

FIG. 2d shows a sectional analysis of the result of a practical experiment made on the basis of a master substrate in accordance with FIGS. 2a to 2c;

FIGS. 3a to 3c schematically show a first example of the second general embodiment of the master substrate in accordance with the invention during processing by a method in accordance with the invention;

FIG. 3d schematically shows the making of a stamper and stamp, respectively;

FIG. 3e schematically shows the making of an optical disc;

FIG. 3f schematically shows the making of a microprint;

FIGS. 4a to 4c schematically show a second example of the second general embodiment of the master substrate in accordance with the present invention during processing by a method in accordance with the invention; and

FIG. 4d shows a sectional analysis of the result of a practical experiment made on the basis of a master substrate in accordance with FIGS. 4a to 4c.

### DESCRIPTION OF PREFERRED EMBODIMENTS

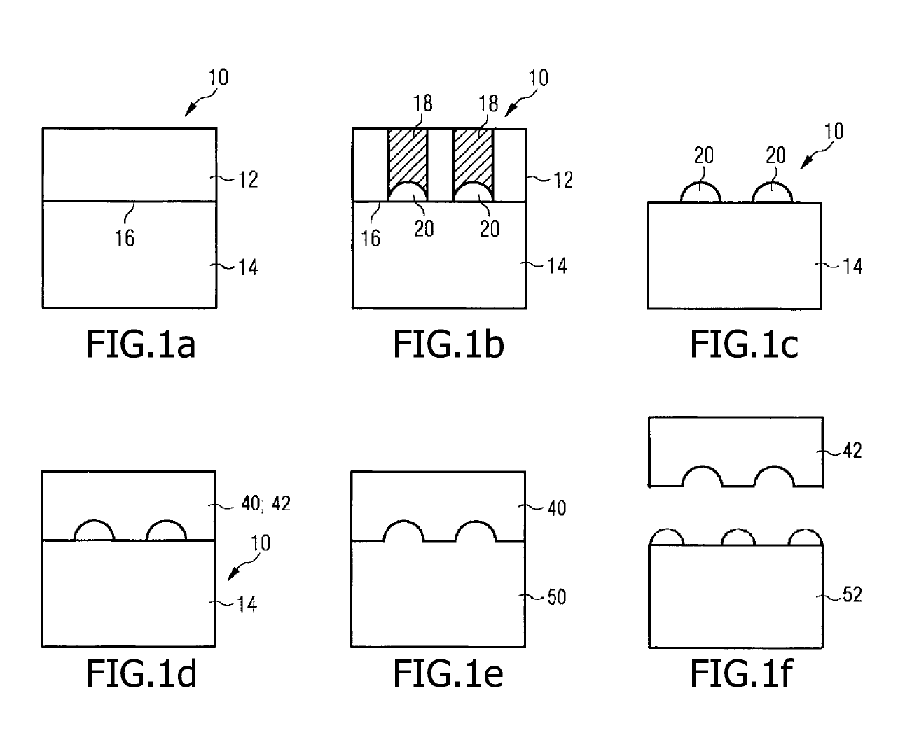

FIGS. 1a to 1c schematically show a first example of the first general embodiment of the master substrate in accordance with the present invention during processing by a method in accordance with the invention, wherein FIG. 1a shows the master substrate 10 untreated, FIG. 1b shows the master substrate 10 after writing, and FIG. 1c shows the master substrate 10 after etching.

The master substrate 10 comprises an organic dye layer 12, wherein the organic dye is for example phthalocyanine. The thickness of the organic dye layer 12 is for example 70 nm. The organic dye layer 12 is carried by a polycarbonate layer 14 having a planar upper surface. Thereby, a dye/polycarbonate interface 16 is formed.

By applying laser pulses to a region 30 of the organic dye layer 12 a bump 20 is formed at the dye/polycarbonate interface 16, as may be seen from FIG. 1b.

FIG. 1c shows the master substrate 10 after etching with iso-propanole. Both the written and the unwritten dye layer are removed, but selective etching is present between the polycarbonate layer 14 and the organic dye layer 12 as well as the bump 20 and the organic dye layer 12.

FIG. 1d schematically shows the making of a stamper 40 and a stamp 42, respectively. The stamper 40 and the stamp 42, respectively, is formed on the basis of the high-density relief structure 24. To provide the metal layer, for example, a thin Ni layer is sputter-deposited on the high-density relief structure 24 formed in the recording stack of the master substrate 10. This Ni layer is subsequently electro-chemically grown to a thick manageable stamper 40 or stamp 42. The stamper 40 or the stamp 42 is separated from the master substrate 10 and further processed (cleaned, punched etc.).

FIG. 1e schematically shows the making of an optical disc 50 on the basis of the stamper 40, as it is well known to the person skilled in the art.

FIG. 1f schematically shows the making of a microprint 52 on the basis of the stamp 42, as it is also well known by the person skilled in the art.

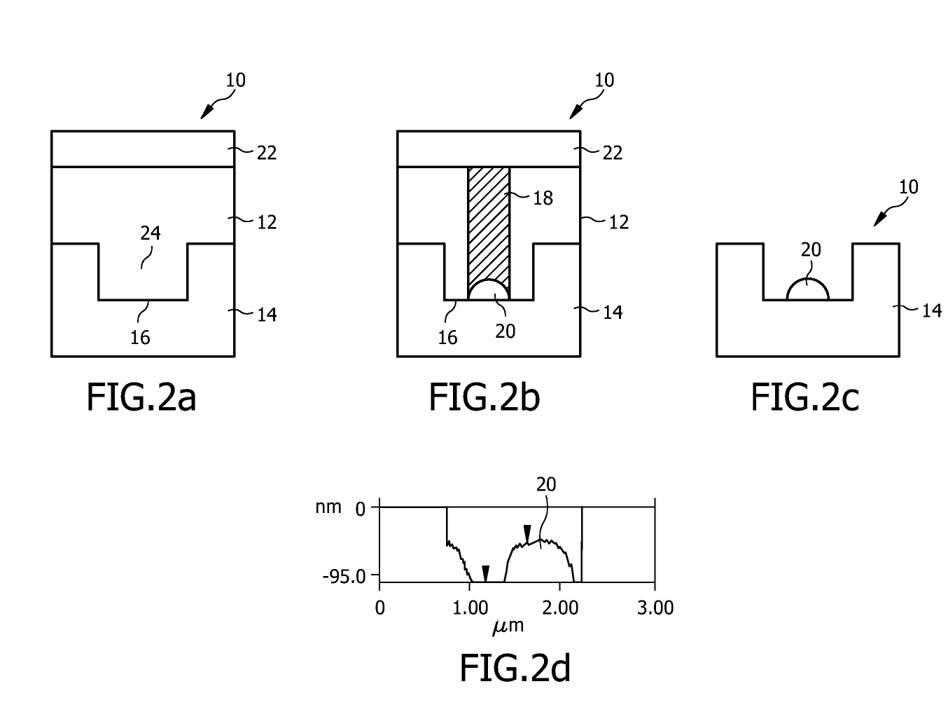

FIGS. 2a to 2c schematically show a second example of the first general embodiment of the master substrate in accordance with the present invention during processing by a method in accordance with the invention, wherein FIG. 2a shows the master substrate 10 untreated, FIG. 2b the master substrate 10 after writing, and FIG. 2c shows the master substrate 10 after etching.

The structure of the recording stack shown in FIG. 2a and its processing is the same as described in connection with FIGS. 1a to 1c, except that the polycarbonate layer 14 comprises a pre-groove 24 in which the bump 20 is formed. Furthermore, there is provided an optional absorption layer 22 on top of the organic dye layer 12 to induce absorption.

The bumps (only one bump 20 is shown) are created in the groove 24 where the majority of the dye is originally present. Phthalocyanine dyes are the most suitable dyes for mastering based on bump formation. For Blu-ray Disc mastering, recording is preferably done with 405 nm, but other wavelengths are also possible. Although phthalocyanine is preferred, all dye materials with sufficient absorption at this wavelength can be used for this application.

FIG. 2d shows a sectional analysis of the result of a practical experiment made on the basis of a master substrate in accordance with FIGS. 2a to 2c. To end up with the structure shown in FIG. 2d, a conventional DVD+R disc was recorded, the metal layer was peeled off, and the remaining written and unwritten dye layer was dissolved in iso-propanole.

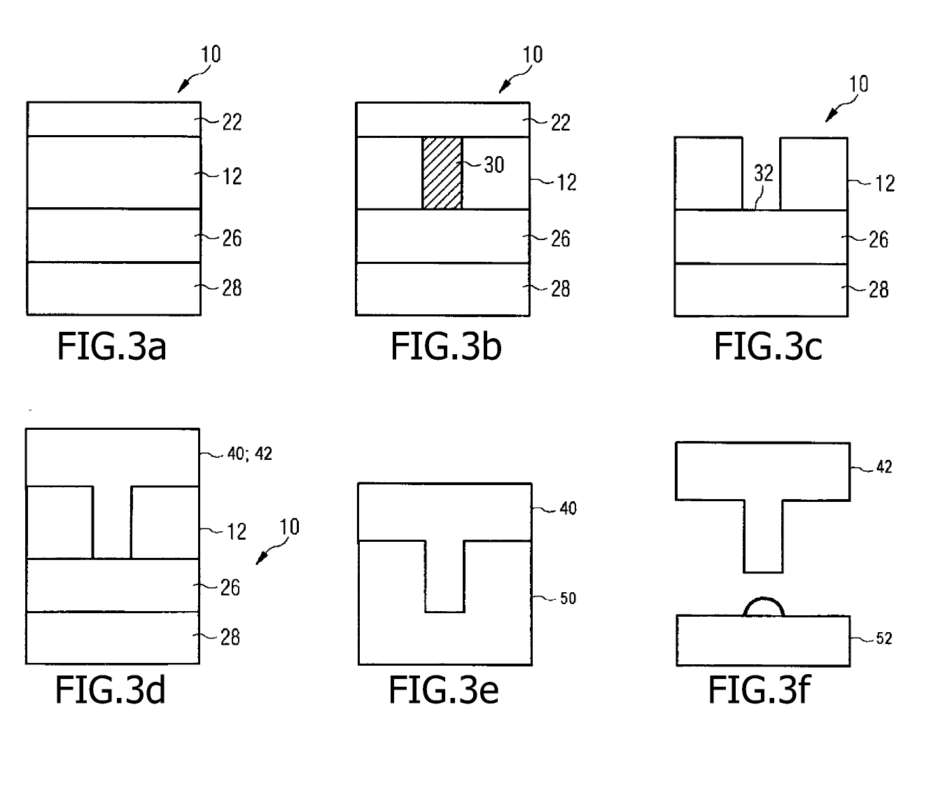

FIGS. 3a to 3c schematically show a first example of the second general embodiment of the master substrate in accordance with the invention during processing by a method in accordance with the invention, wherein FIG. 3a shows the master substrate 10 untreated, FIG. 3b shows the master substrate 10 after writing, and FIG. 3c shows the master substrate 10 after etching.

The recording stack shown in FIG. 3a comprises a glass substrate 28, on which a metallic layer 26 is provided. The metallic layer 26 is provided to enhance the absorption profile in an organic dye layer 12 which is carried by the metallic layer 26. On top of the organic dye layer 12 there is provided an absorption layer 22 to induce absorption.

FIG. 3b shows the master substrate 10 after dye bleaching laser pulses have been applied to bleach a region 30 where a pit is to be formed.

FIG. 3c shows the master substrate 10 after etching, for example with 20% KOH. As may be seen from FIG. 3c the unwritten region of the organic dye layer 12 are still present and form the pit 32. In this way a high density relief structure can be formed.

FIG. 3d schematically shows the making of a stamper 40 and a stamp 42, respectively. The stamper 40 and the stamp 42, respectively, is formed on the basis of the high-density relief structure 20. To provide the metal layer, for example, a thin Ni layer is sputter-deposited on the high-density relief structure 20 formed in the recording stack of the master substrate 10. This Ni layer is subsequently electro-chemically grown to a thick manageable stamper 40 or stamp 42. The stamper 40 or the stamp 42 is separated from the master substrate 10 and further processed (cleaned, punched etc.).

FIG. 1e schematically shows the making of an optical disc 50 on the basis of the stamper 40, as it is well known to the person skilled in the art.

FIG. 1f schematically shows the making of a microprint 52 on the basis of the stamp 42, as it is also well known by the person skilled in the art.

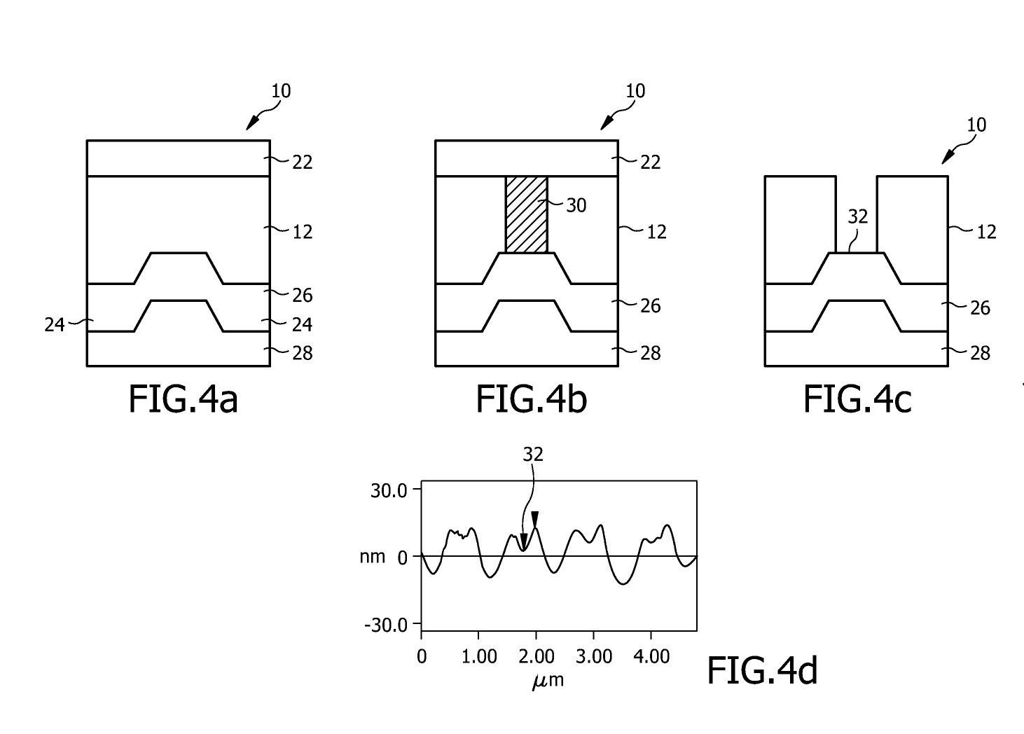

FIGS. 4a to 4c schematically show a second example of the second general embodiment of the master substrate in accordance with the present invention during processing by a method in accordance with the invention, wherein FIG. 4a shows the master substrate 10 untreated, FIG. 4b shows the master substrate 10 after writing, and FIG. 4c shows the master substrate 10 after etching.

The structure of the master substrate 10 as well as its processing is the same as described in connection with FIGS. 3a to 3c, except that the glass substrate 28 comprises a pre-groove 24. As may be seen from FIGS. 4b and 4c, the pit 32 is formed between two adjacent pre-groove portions.

FIG. 4d shows a sectional analysis of the result of a practical experiment made on the basis of a master substrate in accordance with FIGS. 4a to 4c. To end up with an cross section as shown in FIG. 4d, a conventional DVD+R disc was recorded and the written and bleached areas were chemically removed via 20 minutes dissolution in 20% KOH. The groove structure is also clearly visible in FIG. 4d.

The master substrate and the methods in accordance with the invention can for example be used to make stampers for the mass fabrication of BD-ROM and BD-R/RE discs.

Finally, it is to be noted that equivalents and modifications not described above may also be employed without departing from the scope of the invention, which is defined in the accompanying claims.

1. A master substrate (10) for creating a high-density relief structure, particularly a master substrate (10) for making a stamper for the mass fabrication of optical discs or a master substrate for creating a stamp for micro contact printing, wherein an organic dye layer (12) is provided for creating the high-density relief structure.

2. The master substrate (10) according to claim 1, wherein the organic dye layer (12) comprises a planar lower surface.

3. The master substrate (10) according to claim 1, wherein the organic dye layer (12) comprises a pre-grooved lower surface.

4. The master substrate (10) according to claim 1, wherein the dye of the organic dye layer (12) is selected from the following group: AZO, cyanine, phthalocyanine.

5. The master substrate (10) according to claim 1, wherein the organic dye layer (12) is carried by polycarbonate (14).

6. The master substrate (10) according to claim 1, wherein the master substrate (10) comprises a high-density relief structure formed by bumps (20) created by laser pulses at an interface (16) between an organic dye layer (12) and a polycarbonate layer (14).

7. The master substrate (10) according to claim 1, wherein the organic dye layer (12) is arranged above a glass substrate (28).

8. The master substrate (10) according to claim 1, wherein the master substrate comprises a high-density relief structure formed in the organic dye layer.

9. The master substrate (10) according to claim 7, wherein a metallic reflector layer is arranged between the glass substrate and the dye layer.

10. The master substrate (10) according to claim 1, wherein an absorption layer (22) is arranged on top of the dye layer (12).

11. A method for providing a high density relief structure on a master substrate (10) comprising an organic dye layer (12), the method comprising the following steps:
applying dye bleaching laser pulses on regions (30) of the master substrate (10) where pits (32) are to be formed; and
removing the bleached regions (30) of the organic dye layer (12) by an etching process.

12. A method for providing a high density relief structure on a master substrate (10), the method comprising the following steps:
providing a master substrate (10) comprising at least a polycarbonate layer (14) carrying an organic dye layer (12);
forming bumps (20) at the dye/polycarbonate interface (16) by applying laser pulses; and
removing the remaining dye layer by an etching process.

13. A method for making a stamper (40) for the mass fabrication of optical discs (50), the method comprising the following steps:
providing a master substrate (10) comprising an organic dye layer (12);
applying dye bleaching laser pulses on regions (30) of the master substrate (10) where pits (32) are to be formed;
removing the bleached regions (30) of the organic dye layer (12) by an etching process; and
making the stamper (40) on the basis of the master substrate (10).

14. A method for making an optical disc (50), the method comprising the following steps:
providing a master substrate (10) comprising an organic dye layer (12);
applying dye bleaching laser pulses on regions (30) of the master substrate (10) where pits (32) are to be formed;
removing the bleached regions (30) of the organic dye layer (12) by an etching process;
making a stamper (40) on the basis of the master substrate (10); and
using the stamper (40) to make the optical disc (50).

15. A method for making a stamp (42) for micro contact printing, the method comprising the following steps:
providing a master substrate (10) comprising an organic dye layer (12);
applying dye bleaching laser pulses on regions (30) of the master substrate (10) where pits (32) are to be formed;
removing the bleached regions (30) of the organic dye layer (12) by an etching process; and
making the stamp (42) on the basis of the master substrate (10).

16. A method for making a microprint (52), the method comprising the following steps:
providing a master substrate (10) comprising an organic dye layer (12);
applying dye bleaching laser pulses on regions (30) of the master substrate (10) where pits (32) are to be formed;
removing the bleached regions (30) of the organic dye layer (12) by an etching process;
making a stamp (42) on the basis of the master substrate (10); and
using the stamp (42) to make the microprint (52).

17. A method for making a stamper (40) for the mass fabrication of optical discs (50), the method comprising the following steps:
providing a master substrate (10) comprising at least a polycarbonate layer (14) carrying an organic dye layer (12);
forming bumps (20) at the dye/polycarbonate interface (16) by applying laser pulses;
removing the remaining dye layer by an etching process; and
making the stamper (40) on the basis of the master substrate (10).

18. A method for making an optical disc (50), the method comprising the following steps:
providing a master substrate (10) comprising at least a polycarbonate layer (14) carrying an organic dye layer (12);
forming bumps (20) at the dye/polycarbonate interface (16) by applying laser pulses;
removing the remaining dye layer by an etching process;
making a stamper (40) on the basis of the master substrate (10); and
using the stamper (40) to make the optical disc (50).

19. A method for making a stamp (42) for micro contact printing, the method comprising the following steps:
providing a master substrate (10) comprising at least a polycarbonate layer (14) carrying an organic dye layer (12);
forming bumps (20) at the dye/polycarbonate interface (16) by applying laser pulses;
removing the remaining dye layer by an etching process; and
making the stamp (42) on the basis of the master substrate (10).

20. A method for making a microprint (52), the method comprising the following steps:
providing a master substrate (10) comprising at least a polycarbonate layer (14) carrying an organic dye layer (12);
forming bumps (20) at the dye/polycarbonate interface (16) by applying laser pulses;
removing the remaining dye layer by an etching process;
making a stamp (42) on the basis of the master substrate (10); and
using the stamp (42) to make the microprint (52).
